(19) United States
(12) Patent Application Publication
(10) Pub. No.: US 2019/0010058 A1
(43) Pub. Date: Jan. 10, 2019

(54) SYSTEMS AND METHODS FOR CARBON MONOXIDE PRODUCTION BY REDUCTION OF CARBON DIOXIDE WITH ELEMENTAL SULFUR

(71) Applicant: SABIC Global Technologies B.V., Bergen op Zoom (NL)

(72) Inventors: Lawrence D'SOUZA, Thuwal (SA); Sivadinarayana CHINTA, Thuwal (SA)

(21) Appl. No.: 16/067,858

(22) PCT Filed: Dec. 6, 2016
(86) PCT No.: PCT/IB2016/057389

§ 371 Date: Jul. 3, 2018

Related U.S. Application Data
(60) Provisional application No. 62/274,881, filed on Jan. 5, 2016.

(51) Int. Cl. C01B 32/40; C01B 17/50; B01J 8/04

(52) U.S. Cl. CPC C01B 32/40; C01B 17/508; B01J 2219/00054; B01J 8/0488; B01J 8/0411

(57) ABSTRACT

Thermoneutral systems and methods for producing carbon monoxide (CO) and sulfur dioxide (SO₂) are disclosed. The systems can include a first reaction zone and a second reaction zone, where heat generated in the first reaction zone is sufficient to drive a carbon dioxide gas (CO₂(g)) and elemental sulfur gas (S(g)) reaction to produce a product stream that includes CO(g) and SO₂(g).

### CROSS REFERENCE TO RELATED APPLICATIONS

This application claims the benefit of priority of U.S. Provisional Patent Application No. 62/274,881, filed Jan. 5, 2016, which is hereby incorporated by reference in its entirety.

### BACKGROUND OF THE INVENTION

### A. Field of the Invention

The invention generally concerns systems and methods for producing carbon monoxide and sulfur dioxide by reducing carbon dioxide with elemental sulfur. In particular, the systems and methods capture the heat generated by an exothermic reaction of a first reaction mixture to drive the endothermic reaction of carbon dioxide and elemental sulfur.

### B. Description of Related Art

Carbon dioxide is a relatively stable and non-reactive molecule when compared with carbon monoxide. Carbon monoxide can be used to produce several downstream chemical products. For instance, syngas (which includes carbon monoxide and hydrogen gases) is often times used to produce chemicals such as methanol, tert-butyl methyl ether, ammonia, fertilizers, 2-ethyl hexanol, formaldehyde, acetic acid, and 1-4 butane diol.

Syngas can be produced by common methods such as methane steam reforming technology as shown in reaction equation (1), partial oxidation of methane as shown in reaction (2), or dry reforming of methane as shown in reaction (3):

CH₄+H₂O→CO+3H₂ ΔH_{298K}=206 kJ (1)

CH₄+O₂→CO+2H₂ ΔH_{298K}=−8 kcal/mol (2)

CH₄+CO₂→2CO+2H₂ ΔH_{298K}=247 kJ (3)

While the reactions in equations (1) and (2) do not utilize carbon dioxide, equation (3) does. Commercialization attempts of the dry reforming of methane have suffered due to high energy consumption, catalyst deactivation, and applicability of the syngas composition produced in this reaction. Equation (4) illustrates the catalyst deactivation event due to carbonization.

CH₄+2CO₂→C+2CO+2H₂O (4)

Other attempts to convert carbon dioxide into carbon monoxide include the catalyst reduction of carbon dioxide using hydrogen as shown in equation (5).

CO₂+H₂→CO+H₂O ΔH=10 kcal/mol (5)

This process, which is also known as a reverse water gas shift reaction, is mildly endothermic and takes place at temperatures at about 450° C. However, commercialization of this process suffers from the hydrogen availability. In particular, hydrogen is relatively expensive to produce and isolate. Thus, the present costs and sources of hydrogen are not favorable on a commercial scale to convert CO₂ to CO per equation (5).

While other attempts have been made to produce carbon monoxide from carbon dioxide, these attempts have also proven to be inefficient. For instance, Ueno et al., “Catalytic reduction of CO₂ to CO using Sulfur Vapor”, Chemistry Letters, 1980, 1067-1070 describes a method of producing CO and SO₂ at temperatures above 650° C. using various metal oxides that react with sulfur to produce a metal sulfide and SO₂. The metal sulfide then reacts with the carbon dioxide to form carbon monoxide. The reliance on the equilibrium between the metal sulfide and metal oxide results in a limitation of the types of catalysts that can be used in the reaction. U.S. Patent Application Publication No. 20100242478 to Wojak describes combusting sulfur vapor with oxygen to generate heat and reacting the sulfur dioxide with carbonyl sulfide to produce carbon dioxide and sulfur vapor and harnessing the produced energy and steam in gas and steam turbines. The complexity and additional components needed to harness the energy and produce the products also results in an inefficient process that is not commercially viable for producing carbon monoxide.

### SUMMARY OF THE INVENTION

A solution to the problems associated with the production of carbon monoxide from carbon dioxide has been discovered. In particular, the solution resides in the ability to use heat from a first exothermic reaction to drive the less exothermic or endothermic reactions that reduce carbon dioxide with elemental sulfur gas to produce carbon dioxide and sulfur dioxide as shown in reaction equations (6) through (9):

2CO₂(g)+S(g)→2CO(g)+SO₂(g) ΔH_{1378 K}=−4.1 kJ/mol (6)

4CO₂(g)+S₂(g)→4CO(g)+SO₂(g) ΔH_{1378 K}=96.2 kJ/mol (7)

CO(g)+S(g)→COS(g) ΔH_{1378 K}=−74.2 kJ/mol (8)

2CO(g)+S₂(g)→2COS(g) ΔH_{1378 K}=−44 kJ/mol (9)

In particular, the heat generated from the reaction of COS and oxygen (O₂), shown in equation (10), can be used to drive the reactions of equations (6) through (9).

COS(g)+1.5O₂(g)→CO₂(g)+SO₂(g) ΔH_{773 K}=−131 kJ/mol (10)

Notably, the system is designed to be thermoneutral. Further, the methods of the present invention can minimize natural gas consumption, can utilize carbon dioxide produced as a byproduct in the production of many petrochemicals, and can economically convert carbon dioxide and elemental sulfur into value added chemical products (e.g., CO, SO₂, and COS).

In a particular aspect, a system for the production of carbon monoxide and sulfur dioxide is described. The system can include (a) a first reaction zone configured to produce heat from an exothermic reaction of a first reaction mixture and a first product stream; (b) a second reaction zone that includes a gaseous reaction mixture of CO₂ and elemental sulfur and configured to receive the produced heat from the first reaction zone in an amount sufficient to heat the gaseous reaction mixture and produce a second product stream comprising CO and SO₂; (c) a first outlet in fluid communication with the first reaction zone and configured to remove the first product stream from the first reaction zone; and (d) a second outlet in fluid communication with the second reaction zone and configured to remove the second product stream comprising CO and SO₂ from the second reaction zone. The exothermic first reaction mixture can include COS and an oxygen source O₂ and the first product stream includes CO₂ and SO₂ generated by the combustion of the COS. The oxygen source can be air, oxygen enriched air and/or oxygen gas. In some embodiments, the second reaction zone encompasses the first reaction zone. Such a configuration can form a concentric reactor and the annulus of the concentric reactor can be the first reaction zone. Heat generated from the first reaction zone can be transferred from the first reaction zone to the second reaction zone in an amount sufficient to drive the carbon dioxide and elemental sulfur reaction and/or a carbon monoxide and elemental sulfur reaction. In certain embodiments, the first product stream absorbs heat from the exothermic reaction, and the system further includes a heat exchanging unit in fluid communication with the first outlet and the second reaction zone and configured to exchange heat between the heated first product stream and a gaseous reaction feed stream and provide the heated gaseous reaction feed stream to the second reaction zone, where the gaseous feed stream comprises CO₂ and elemental sulfur. The heat transferred to the gaseous reaction feed stream is sufficient to drive the carbon dioxide and elemental sulfur reaction and/or a carbon monoxide and elemental sulfur reaction. The temperature of the produced heat can be at least 250° C. or 250° C. to 2500° C., preferably 900° C. to 2300° C., most preferably 1000° C. to 2200° C. In some embodiments, the first reaction outlet is configured to provide the produced heat to another system, preferably a power generating system. In certain embodiments, the second reaction zone includes a catalyst (e.g., a bulk metal catalyst or a supported catalyst) capable of catalyzing the reaction of CO₂ and elemental sulfur to produce the second product stream that includes COS, CO and SO₂. The catalyst can include a metal, a metal oxide, a metal sulfide, a lanthanide, a lanthanide oxide, or any combination thereof. The metal, metal oxide, or metal sulfide can include a Group IIA, IB, IIB, IIIB, IVB, VIB, or VIII metal or iron, manganese, copper, nickel, cobalt. The lanthanide or lanthanide oxide can include La, Ce, Dy, Tm, Yb, Lu, CeO₂, Dy₂O₃, Tm₂O₃, Yb₂O₃, Lu₂O₃, or La₂O₃, or any combination thereof. Supported catalysts can include a support that includes a metal sulfide, a metal carbide, a metal nitride, or a metal phosphate, and any combination thereof. The system can include one or more separation units to separate the first product stream and the second product stream into separate components.

In yet another aspect, an energy neutral methods of producing carbon monoxide and sulfur dioxide are described. The method can include (a) providing a first reaction mixture capable of undergoing an exothermic reaction to subjecting the first reaction mixture to conditions sufficient to produce a first product stream and heat; (b) providing a second reaction mixture that includes CO₂ and elemental sulfur gas to a second reaction zone; (c) transferring the produced heat to the second reaction zone; and (d) producing a second product stream can include CO and SO₂ and, optionally, COS from the second reaction mixture. The first reaction mixture can include COS and O₂ and the first product stream that includes CO₂ and SO₂. Transferring the produced heat in step (c) can include allowing the heat to transfer from the first reaction zone to the second reaction zone and/or transferring the produced heat from the first product stream to the second product stream and the transferred heat provides sufficient heat to drive the carbon dioxide (CO₂) and elemental sulfur gas reaction or a carbon monoxide and elemental sulfur reaction, or both. The temperature in the first reaction zone is at least 700° C. or 700° C. to 2500° C., preferably 900° C. to 2300° C., most preferably 1000° C. to 2500° C. at a pressure of 0.1 to 50 bar and the temperature of the produced heat can be at least 250° C., or 250° C. to 2500° C., preferably 900° C. to 2400° C., most preferably 1000° C. to 2200° C. The temperature of the second reaction mixture can be 250° C. to 3000° C., preferably 900° C. to 2000° C., most preferably 1000° C. to 1600° C. at a pressure of 1 to 25 bar. The first reaction mixture can include COS and O₂ and the mole ratio of O₂:COS can range from 0.1 to 2.5, or 1.5. Combustion of the COS produces the heat and a second product stream that include CO₂ and SO₂. In certain instances, the first and/or second product streams are collected. In some instances, some of the produced heat can be transferred to another processing zone, for example, to an energy generating unit. In some instances, the second reaction zone can include catalyst capable of catalyzing the reaction of CO₂ and elemental sulfur to produce the second product stream that includes COS, CO and SO₂. The catalyst can include a metal, a metal oxide, a metal sulfide, a lanthanide, a lanthanide oxide, or any combination thereof. The metal, metal oxide, or metal sulfide can include a Group IIA, IB, IIB, IIIB, IVB, VIB, or VIII metal or iron, manganese, copper, nickel, cobalt. The lanthanide or lanthanide oxide can include La, Ce, Dy, Tm, Yb, Lu, CeO₂, Dy₂O₃, Tm₂O₃, Yb₂O₃, Lu₂O₃, or La₂O₃, or any combination thereof. Supported catalysts can include a support that includes a metal sulfide, a metal carbide, a metal nitride, or a metal phosphate, and any combination thereof.

In the context of the present invention 45 embodiments are described. Embodiment 1 is a system for producing carbon monoxide (CO) and sulfur dioxide (SO₂), the system can include: (a) a first reaction zone configured to produce heat from an exothermic reaction of a first reaction mixture and a first product stream; (b) a second reaction zone comprising a gaseous reaction mixture of carbon dioxide (CO₂(g)) and elemental sulfur and configured to receive the produced heat from the first reaction zone in an amount sufficient to heat the gaseous reaction mixture and produce a second product stream comprising CO and SO₂; (c) a first outlet in fluid communication with the first reaction zone and configured to remove the first product stream from the first reaction zone; and (d) a second outlet in fluid communication with the second reaction zone and configured to remove the second product stream comprising CO and SO₂ from the second reaction zone. Embodiment 2 is the system of embodiment 1, wherein exothermic first reaction mixture comprises carbonyl sulfide (COS) and oxygen source oxygen (O₂) and the first product stream comprises CO₂ and SO₂. Embodiment 3 is the system of any one of embodiments 1 to 2, wherein the second reaction zone encompasses the first reaction zone. Embodiment 4 is the system of embodiment 3, wherein the first reaction zone and the second reaction zone form a concentric reactor. Embodiment 5 is the system of embodiment 4, wherein the first reaction zone is the annulus of the concentric reactor. Embodiment 6 is the system of any one of embodiments 1 to 5, wherein the first product stream absorbs heat from the exothermic reaction, and the system further comprises a heat exchanging unit in fluid communication with the first outlet and the second reaction zone and configured to exchange heat between the heated first product stream and the second reaction mixture and providing the heated second reaction mixture to the second reaction zone. Embodiment 7 is the system of embodiment 6, wherein second gaseous reaction mixture further comprises CO₂ and elemental sulfur. Embodiment 8 is the system of any one of embodiments 1 to 7, wherein the produced heat from the first reaction zone is sufficient to drive the CO₂ with the elemental sulfur reaction, a CO and elemental sulfur reaction, or both in the second reaction zone. Embodiment 9 is the system of any one of embodiments 1 to 8, wherein the temperature of the produced heat is at least 250° C. Embodiment 10 is the system of embodiment 9, wherein the temperature of the produced heat is 250° C. to 2500° C., preferably 900° C. to 2300° C., most preferably 1000° C. to 2200° C. Embodiment 11 is the system of any one of embodiments 1 to 10, wherein the system is thermoneutral. Embodiment 12 is the system of any one of embodiments 1 to 11, wherein the first reaction outlet is configured to provide the produced heat to another system, preferably a power generating system. Embodiment 13 is the system of any one of embodiments 1 to 12, wherein the second reaction zone comprises a catalyst capable of catalyzing the reaction of CO₂ and elemental sulfur to produce the second product stream comprising COS, CO and SO₂. Embodiment 14 is the system of embodiment 13, wherein the catalyst comprises a metal, a metal oxide, a metal sulfide, a lanthanide, a lanthanide oxide, or any combination thereof. Embodiment 15 is the system of embodiment 14, wherein the metal, metal oxide, or metal sulfide includes a Group IIA, IB, IIB, IIIB, IVB, VIB, or VIII metal. Embodiment 16 is the system of embodiment 15, wherein the metal sulfide comprises molybdenum or zinc. Embodiment 17 is the system of embodiment 16, wherein the lanthanide or lanthanide oxide includes La, Ce, Dy, Tm, Yb, Lu, CeO₂, Dy₂O₃, Tm₂O₃, Yb₂O₃, Lu₂O₃, or La₂O₃, or any combination thereof. Embodiment 18 is the system of embodiment 13, wherein the catalyst is a bulk metal catalyst. Embodiment 19 is the system of embodiment 13, wherein the catalyst is a supported catalyst. Embodiment 20 is the system of embodiment 19, wherein the support comprises a metal sulfide, a metal carbide, a metal nitride, or a metal phosphate, and any combination thereof. Embodiment 21 is the system of any one of embodiments 1 to 20, wherein the second product stream comprises COS.

Embodiment 22 is a method of producing carbon monoxide (CO) and sulfur dioxide (SO₂), the method comprising: (a) providing a first reaction mixture capable of undergoing an exothermic reaction to a first reaction zone; (b) subjecting the first reaction mixture to conditions sufficient to produce a first product stream and heat; (c) providing a second reaction mixture comprising carbon dioxide (CO2) and elemental sulfur gas to a second reaction zone; (d) transferring the produced heat to the second reaction zone; and (e) producing a second product stream comprising CO and SO2 from the second reaction mixture. Embodiment 23 is the method of embodiment 22, wherein the first reaction mixture comprises carbonyl sulfide (COS) and oxygen gas (O₂) and the first product stream comprises CO₂ and SO₂. Embodiment 24 is the method of any one of embodiments 22 to 23, wherein transferring the heat comprises allowing the heat to transfer from the first reaction zone to the second reaction zone and/or transferring the produced heat from the first product stream to the second product stream. Embodiment 25 is the method of any one of embodiments 22 to 24, wherein the temperature of the second reaction mixture is 250° C. to 3000° C., preferably 900° C. to 2000° C., most preferably 1000° C. to 1600° C. Embodiment 26 is the method of embodiment 25, wherein the reaction pressure in the second reaction zone is 1 to 25 bar. Embodiment 27 is the method of any one of embodiments 22 to 26, wherein the transferred heat provides sufficient heat to drive the carbon dioxide (CO₂) and elemental sulfur gas reaction or a carbon monoxide and elemental sulfur reaction, or both in the second reaction zone. Embodiment 28 is the method of any one of embodiments 22 to 27, wherein the method is energy neutral. Embodiment 29 is the method of any one of embodiments 22 to 28, further comprising transferring the produced heat to an energy generating unit. Embodiment 30 is the method of any one of embodiments 22 to 29, wherein the temperature in the first reaction zone is at least 1000° C. Embodiment 31 is the method of any one of embodiments 22 to 30, wherein the reaction temperature in step (b) is 700° C. to 2500° C., preferably 900° C. to 2300° C., most preferably 1000° C. to 2500° C. Embodiment 32 is the method of any one of embodiments 22 to 31, wherein reaction pressure in the first reaction zone is 0.1 to 50 bar. Embodiment 33 is the method of any one of embodiments 22 to 32, wherein the second reaction zone comprises a catalyst capable of catalyzing the reaction of CO₂ and elemental sulfur to produce the second product stream comprising COS, CO and SO₂. Embodiment 34 is the method of embodiment 33, wherein the catalyst comprises a metal, a metal oxide, a metal sulfide, a lanthanide, a lanthanide oxide, or any combination thereof. Embodiment 35 is the method of 34, wherein the metal, metal oxide, or metal sulfide includes a Group IIA, IB, IIB, IIIB, IVB, VIB, or VIII metal. Embodiment 36 is the method of embodiment 35, wherein the metal sulfide comprises molybdenum, iron, manganese, copper, nickel, cobalt or zinc. Embodiment 37 is the method embodiment 36, wherein the lanthanide, or lanthanide oxide includes La, Ce, Dy, Tm, Yb, Lu, CeO₂, Dy₂O₃, Tm₂O₃, Yb₂O₃, Lu₂O₃, or La₂O₃, or any combination thereof. Embodiment 38 is the method of embodiment 33, wherein the catalyst is a bulk metal catalyst. Embodiment 39 is the method of embodiment 33, wherein the catalyst is a supported catalyst. Embodiment 40 is the method of embodiment 39, wherein the support comprises a metal sulfide, a metal carbide, a metal nitride, or a metal phosphate, and any combination thereof. Embodiment 41 is the method of any one of embodiments 23 to 40, further comprising collecting the first and/or second product streams. Embodiment 42 is the method of any one of embodiments 23 to 41, wherein the temperature of the produced heat is at least 250° C. Embodiment 43 is the method of embodiment 42, wherein the temperature of the produced heat is 250° C. to 2500° C., preferably 900° C. to 2400° C., most preferably 1000° C. to 2200° C. Embodiment 44 is the method of any one of embodiments 22 to 43, wherein the second product stream comprises COS. Embodiment 45 is the method of any one of embodiments 22 to 43, wherein a mole ratio of O₂:COS is 0.1 to 2.5, or 1.5.

The following includes definitions of various terms and phrases used throughout this specification.

“Gaseous elemental sulfur” is defined as gaseous allotropes of sulfur, namely, Sₙ, where n is 1 to infinity. In a preferred embodiment, n is 1 to 3.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “bulk metal oxide catalyst” as that term is used in the specification and/or claims, means that the catalyst includes one or more metals, or metal oxides/metal sulfides or metal nitrides and does not require a carrier or an inert support.

The term “substantially” and its variations are defined as to include the ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The systems and methods of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the methods of the present invention are their abilities to produce carbon monoxide and sulfur dioxide in an energy efficient manner.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1 is an illustration of various products that can be produced from syngas.

FIG. 2 is a schematic of a concentric reactor system of the present invention.

FIGS. 3 and 4 are cross-sectional views of different types of concentric reactors.

FIG. 5 is a schematic of two-reactor system of the present invention.

FIG. 6 is a schematic of a membrane separation system for the separation of SO₂ and CO the present invention.

FIG. 7 is a schematic of a cryogenic distillation system for the separation of SO₂ and CO of the present invention.

FIG. 8 is a schematic of a cryogenic distillation system for the separation of SO₂ and CO₂ of the present invention.

FIG. 9 is a graph of conversion of COS with oxygen versus heat trace across the reactor bed.

FIG. 10 is a graph of conversion of CO with sulfur versus heat trace across the reactor bed.

FIG. 11 is a graph of conversion of CO₂ with sulfur versus heat trace across the reactor bed.

### DETAILED DESCRIPTION OF THE INVENTION

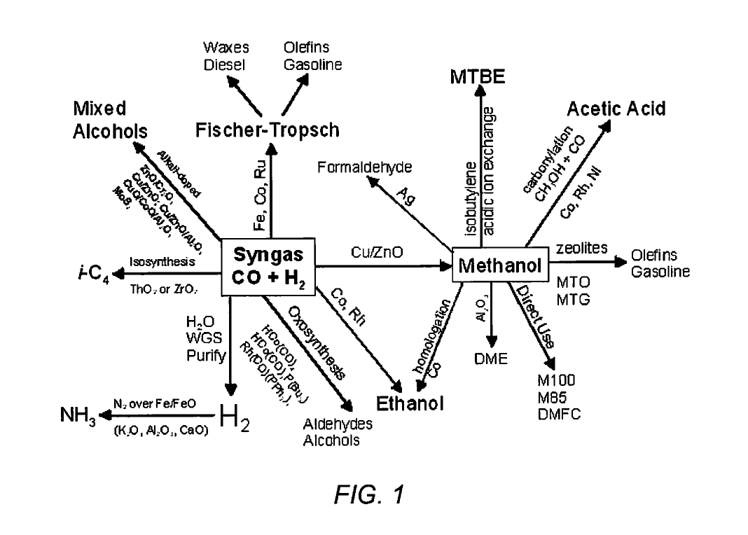

The present invention provides a solution to the current energy requirements associated with converting carbon dioxide to carbon monoxide. The solution resides in a system that allows heat to be transferred from a first reaction mixture to a second reaction mixture. Such a system can be thermoneutral and/or energy neutral. The heat can be produced from an exothermic reaction mixture, preferably, from the combustion of COS. The amount of heat produced can be sufficient to drive the reaction of CO₂ and elemental sulfur to form CO, SO₂ and COS and the intermediate CO and elemental sulfur reaction. The resulting product stream can be separated and used in industrial and/or energy applications. For example, The COS can be used to produce herbicides (e.g., thiocarbamate herbicides) and/or recycled to be used as a fuel source in the first reaction zone. The produced carbon monoxide can be converted to syngas by converting part of the carbon monoxide to into hydrogen gas by the water gas shift reaction (See, equation (5)). Syngas can be used in a variety of processes to produce desired chemicals, examples of which are provided in FIG. 1. The produced SO₂ can be converted into SO₃ and then sulfuric acid and ultimately ammonium sulfate fertilizers. These and other non-limiting aspects of the present invention are discussed in further detail in the following sections.

### A. Systems

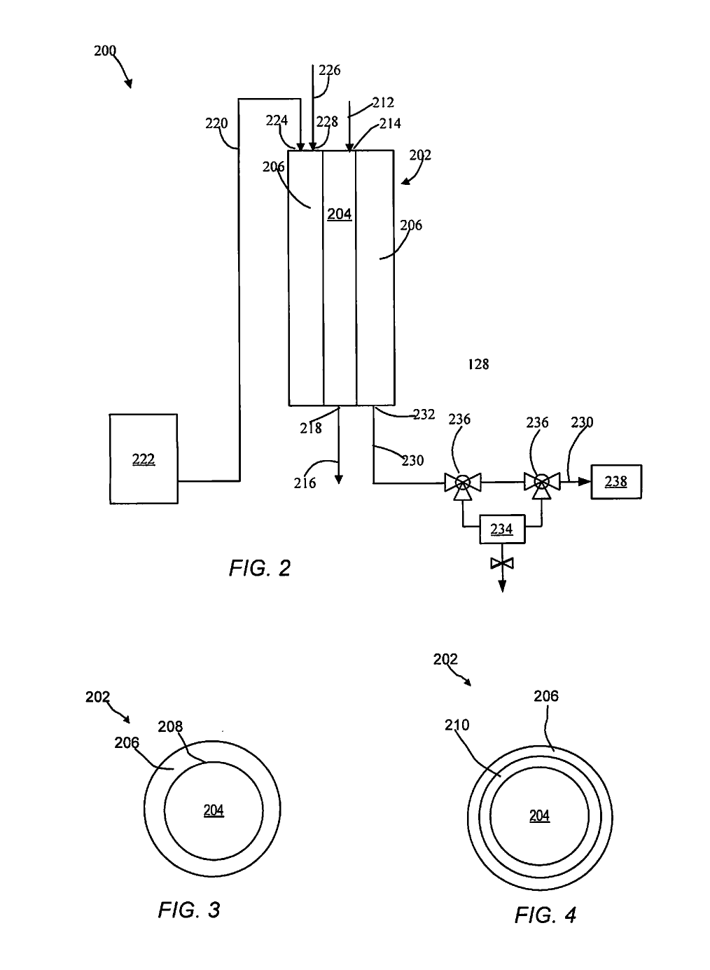

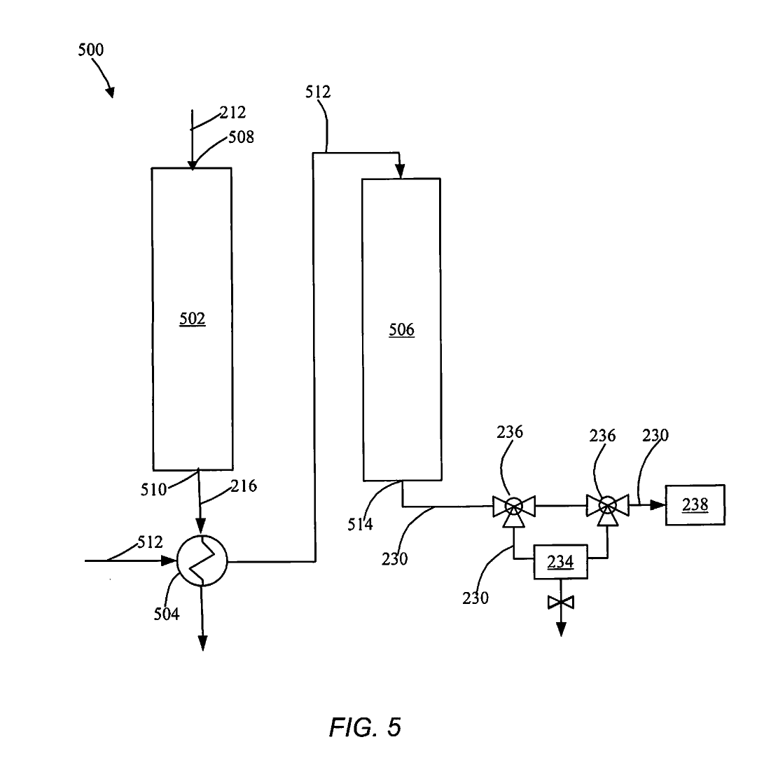

The reaction of carbon dioxide and sulfur can be performed at conditions to produce a product stream that includes carbonyl sulfide, carbon monoxide and sulfur dioxide. Non-limiting examples of systems for the reduction of carbon dioxide to carbon monoxide in the presence of sulfur are illustrated with reference to the Figures. FIGS. 2-5 are schematics of reactor systems 200 and 500 of the present invention. In FIG. 2, a system that includes a concentric reactor. FIG. 3 is a cross-sectional view of concentric reactor with a first reaction zone and a second reaction zone with a common wall. FIG. 4 is a cross-sectional view of a concentric reactor have an annulus between the first reaction zone and the second reaction zone. FIG. 5 depicts a system with two reactors in series in combination with a heat exchanging unit. The reactors used in FIG. 5 can be fixed-bed reactors, stacked bed reactors, fluidized bed reactors, slurry or ebullating bed reactors, spray reactors, concentric reactors, or plug flow reactor. The reactors in all the systems can be manufactured from material resistant to corrosion from sulfur and/or carbon dioxide. A non-limiting example of such material is stainless steel.

1. Concentric Reactor System

Referring to FIG. 2A, system 200 includes reaction unit 202 having a first reaction zone 204 and a second reaction zone 206. The reaction unit 202 can be a concentric type reaction vessel, a tube-in-tube type reaction unit, or a multiple tube-in-tube type reaction unit. FIGS. 3 and 4 are cross-sectional views of the concentric reactor. As shown in FIG. 3, first reaction zone 204 is the annulus of the reaction unit that is encompassed by second reaction zone 206 with the first reaction zone 204 and the second reaction zone 206 share a common wall 208. As shown in FIG. 4, annulus 210 can exist between the first reaction zone 204 and the second reaction zone 206. While only one annulus 210 is shown, it should be understood that multiple annuluses can be used and multiple reaction zones 206. The concentric reactor 202 shown in FIGS. 3 and 4 can be designed for maximum heat transfer from the first zone 204 to the second zone 206. A first reaction mixture 212 can enter the first reaction zone 204 via first reaction zone inlet 214. In a non-limiting example the first reaction mixture can include COS and O₂. In some embodiments, the first reaction mixture can include CO₂ as a diluent gas. In some instances, reactants in the first reaction mixture enter the reaction zone 204 via two separate inlets (e.g., a COS inlet and an O₂ inlet). The first reaction zone can be equipped with one or more heat sources (not shown) that provide heat to the first reaction mixture 212 as it enters the reaction zone, or in the reaction zone 204. Heat may be provided to the first reaction mixture in an amount sufficient to combust the first reaction mixture and form a first product stream. When the reaction mixture includes COS and O₂, the first reaction mixture can be heated to a temperature of 700° C. to 2500° C., or 900° C. to 2300° C., 1000° C. to 2500° C., or about 700° C., 750° C., 800° C., 850° C., 900° C., 950° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., or 2500° C. The reaction mixture can react (e.g., combust) and form the second product stream CO₂ and SO₂ and heat. A first product stream 216 can exit the first reaction zone 204 via first product outlet 218. In some instances, the first product stream can include CO₂ and SO₂. The first product stream 216 can be collected, separated, transported, sold or provided to other processing units for further processing.

The heat from the first reaction zone 204 can transfer from the reaction mixture to the wall 208 or annulus 210 of the reaction unit 202 and then to the second reaction zone 206. The temperature of the produced heat can be at least 250° C. or range from 250° C. to 2500° C., preferably 900° C. to 2400° C., most preferably 1000° C. to 2200° C., or about 250° C., 300° C., 350° C., 400° C., 450° C., 500° C., 550° C., 600° C., 650° C., 700° C., 750° C., 800° C., 850° C., 900° C., 950° C., 1000° C., 1100° C., 1200° C., 1300° C., 1400° C., 1500° C., 1600° C., 1700° C., 1800° C., 1900° C., 2000° C., 2100° C., 2200° C., 2300° C., or 2400° C., or any value or any range there between. In the second reaction zone 206, gaseous elemental sulfur 220 enters the second reaction zone 206 from elemental sulfur storage unit 222 via elemental sulfur inlet 224. In some aspects, solid sulfur is heated in storage vessel 222 to about 250° C. to liquefy the molten sulfur. Storage vessel may be to 250 to 300° C. to maintain the sulfur in a liquid phase. Molten sulfur can exit storage vessel 222, and be pumped to reaction vessel. The components of the sulfur line and the inlet to the section reaction zone can be heated to 250 to 300° C. to inhibit solidification of the molten sulfur in the sulfur line. Flow of the molten sulfur into second reaction zone 206 can be altered using flow switches and/or controllers known in the art.

Reaction gas (for example, carbon dioxide) 226 can enter the second reaction zone 206 via inlet 228. The gas conduit 120 may include one or more controllers or flow switches to control the flow of gas into the second reaction zone 206. In some embodiments, the gaseous reaction mixture and/or the elemental sulfur are sprayed into the second reaction zone. Second reaction zone 206 can be heated to above the boiling point of sulfur, for example above 415° C., or 250° C. to 3000° C., 900° C. to 2000° C., 1000° C. to 1600° C., or about 300° C., 400° C., 500° C., 600° C., 700° C., 800° C., 900° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., or 3000° C., or any value or range there between, by transfer of heat from the first reaction zone. In some embodiments, the reactant gas is mixed with the hot elemental sulfur prior to entering the second reaction zone 206. As the aerosol mixture of sulfur and/or reaction gas enters the second reaction zone, the sulfur vaporizes or transforms into a gas phase. The gaseous sulfur and reaction gases react in the second reaction zone 206 of reactor 202 to form the reaction products described throughout the Specification. For example, gaseous sulfur reacts with carbon dioxide in the reaction zone to form a gaseous mixture. The gaseous mixture can include CO(g), SO₂(g), COS(g), or any combination thereof. In some instances, gaseous sulfur is also in the produced gaseous mixture. As shown, the first reaction zone 204 and the second reaction zone 206 do not include a catalyst. In some aspects of the invention, the first reaction zone 204 does not include a catalyst and the second reaction zone 206 can include one or more catalysts described throughout the Specification positioned in the reaction zone. The gaseous mixture can flow through the second reaction zone 206 and contact the catalyst in the second reaction zone 206. Such contact can produce the gaseous product mixture.

The gaseous mixture 230 can exit the second reaction zone 206 through reactor outlet 232 and enter separation unit 234. Valves 236 can route a portion of the gaseous mixture 230 to analyzer 238. For example, valves 236 may be three-way valves. Analyzer 238 may be any suitable instrument capable of analyzing a gaseous mixture. A non-limiting example of an analyzer is a gas chromatograph in combination with a mass spectrometer (GC/MS). The condenser 234 can cool the gaseous mixture to a temperature suitable to condense sulfur dioxide, gaseous sulfur, if present, or both from the gaseous mixture. Condenser 234 may be part of a recovery unit that separates the components of the gaseous mixture. Such a recovery unit is described in more detail in the following sections.

2. Two Reactor and Heat Exchanger System

Referring to FIG. 5, a schematic of a two reactor system 500 is described. The system 500 can include first reactor 502, heat exchanging unit 504, and second reactor 506. A first reaction mixture 212 can enter the first reactor 502 via first reaction zone inlet 508. In a non-limiting example, the first reaction mixture can include COS and O₂. In some embodiments, the first reaction mixture can include CO₂ as a diluent gas. In some instances, reactants in the first reaction mixture enter the first reactor 502 via two separate inlets (e.g., a COS inlet and an O₂ inlet). The first reactor 502 can be equipped with one or more heat sources (not shown) that provide heat to the first reaction mixture 212 as it enters the reaction zone, or in the reactor 502 (first reaction zone). Heat may be provided to the first reaction mixture 212 in an amount sufficient to combust the first reaction mixture and form a first product stream 216. When the reaction mixture includes COS and O₂, the first reaction mixture can be heated to a temperature of 700° C. to 2500° C., or 900° C. to 2300° C., 1000° C. to 2500° C., or about 700° C., 750° C., 800° C., 850° C., 900° C., 950° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., or 2500° C., or any value or range there between. The reaction mixture can react (e.g., combust) and form the second product stream CO₂ and SO₂ and heat. The first product stream 216 can exit the first reactor 502 via first product outlet 510. In some instances, the first product stream can include CO₂ and SO₂ and absorbed heat.

The first product stream 216 and second reaction mixture feed stream 512 can enter heat exchanging unit 504. As shown, heat exchanging unit 504 is one heat exchanger, however, the heat exchanger unit can include multiple (e.g., 2, 3, 4 or more) heat exchanging units. Heat exchanging unit can be a shell-in-tube type heat exchanger, a plate heat exchanger, or any other type of heat exchanging unit that is capable of exchanging heat from one gaseous stream to another gaseous stream. While shown as a standalone unit, heat exchanging unit 504 can be a part of the first and/or second reactor. The temperature of the first product stream 216 can be at least 250° C. or range from 250° C. to 2500° C., preferably 900° C. to 2400° C., most preferably 1000° C. to 2200° C., or about 250° C., 300° C., 350° C., 400° C., 450° C., 500° C., 550° C., 600° C., 650° C., 700° C., 750° C., 800° C., 850° C., 900° C., 950° C., 1000° C., 1100° C., 1200° C., 1300° C., 1400° C., 1500° C., 1600° C., 1700° C., 1800° C., 1900° C., 2000° C., 2100° C., 2200° C., 2300° C., or 2400° C., or any value or any range there between. In heat exchanger unit 504, all or a portion of the heat from the first product stream 216 can be exchanged with the second reaction mixture feed stream 512. Heated feed stream 512 can enter second reactor 506 through sprayer 514. The temperature of the heated feed stream 512 can range from above 415° C., or 250° C. to 3000° C., 900° C. to 2000° C., 1000° C. to 1600° C., or 300° C., 400° C., 500° C., 600° C., 700° C., 800° C., 900° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., or 3000° C., or any value or range there between. In some instances, the second reactor 506 is heated using one or more heated source (e.g., electrical heat, jacketed heat) so no heat is lost when the heated feed stream 512 enters the second reactor. In certain aspects, the reaction between CO₂ and elemental sulfur is initiated as the feed stream 512 is being heated in the heat exchanger. In some embodiments, the heat exchanging unit is the second reactor 506. The gaseous sulfur and reaction gases react in the second reactor 506 to form the reaction products described throughout the Specification. For example, gaseous sulfur reacts with carbon dioxide in the reaction zone to form a gaseous mixture. The gaseous mixture can include CO(g), SO₂(g), COS(g), or any combination thereof. In some instances, gaseous sulfur is also in the produced gaseous mixture. As shown, the first reactor 502 and the second reactor 506 do not include a catalyst. In some aspects of the invention, the first reactor 502 does not include a catalyst and the second reactor 506 can include one or more catalysts described throughout the specification positioned in the reaction zone. The gaseous mixture can flow through the second reactor 502, through the heat exchanging unit 504, and contact the catalyst in the second reactor 506. Such contact can produce the gaseous product mixture.

The gaseous second product stream 230 can exit the second reactor 506 through reactor outlet 514 and enter separation unit 234. Valves 236 can route a portion of the gaseous mixture 230 to analyzer 238. For example, valves 236 may be three-way valves. Analyzer 238 may be any suitable instrument capable of analyzing a gaseous mixture. A non-limiting example of an analyzer is a gas chromatograph in combination with a mass spectrometer (GC/MS). The condenser 234 can cool the gaseous mixture to a temperature suitable to condense sulfur dioxide, gaseous sulfur, if present, or both from the gaseous mixture. Condenser 234 may be part of a recovery unit that separates the components of the gaseous mixture. Such a recovery unit is described in more detail in the following sections.

3. Product Recovery Systems

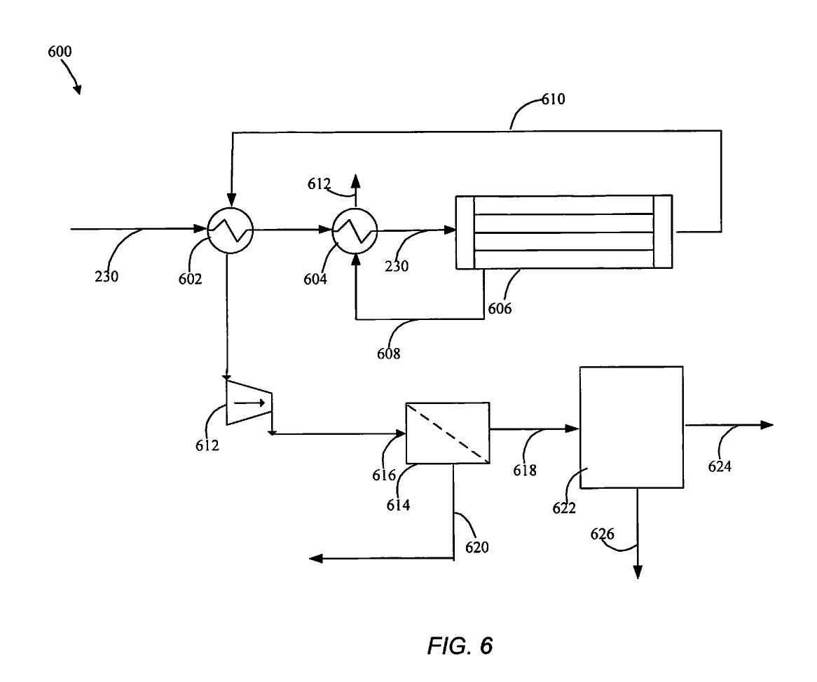

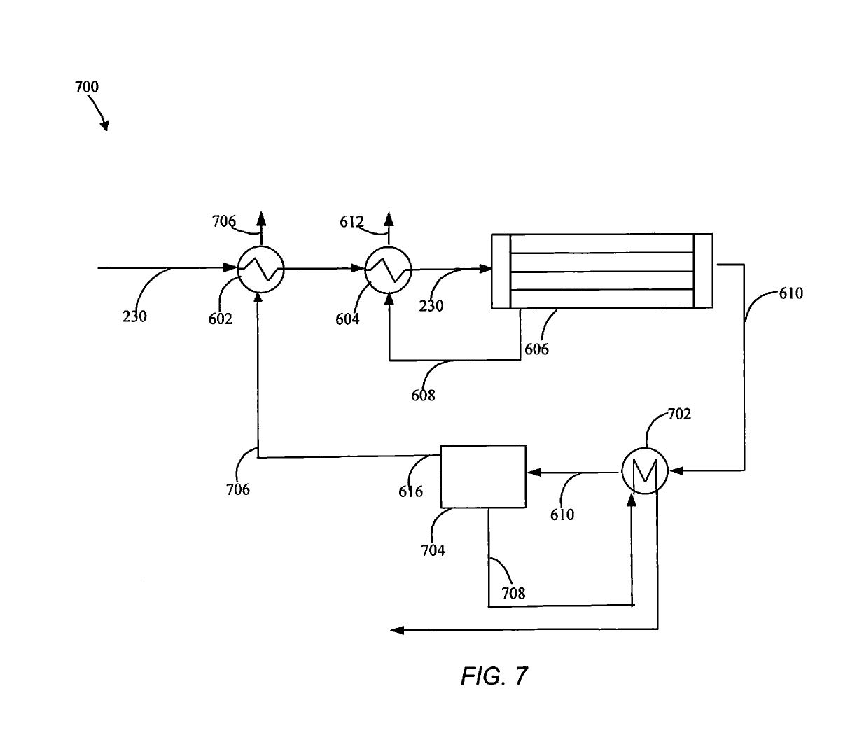

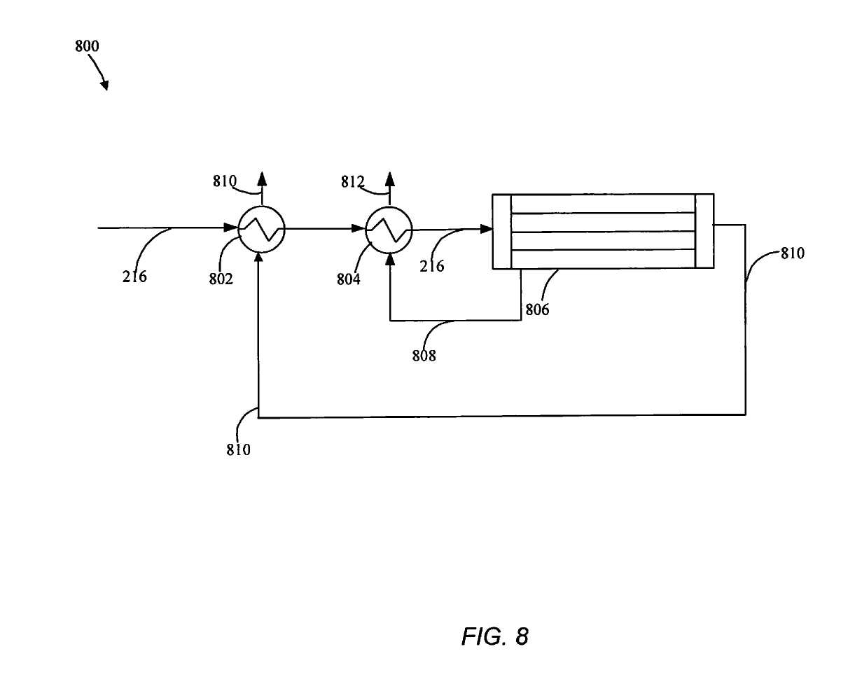

In some aspects of the process, the components of the gaseous product mixture can be separated into sulfur, sulfur dioxide, carbonyl sulfide, carbon monoxide or combinations thereof using known separation technology methods. In some embodiments, thermal-based separation systems (e.g., condensation, distillation) can be used to remove each component and produce a pure stream of CO. Other forms of separation, such as chemi- and physi-sorption systems can also be used to remove particular components. For example, carbon dioxide (CO₂) can be removed using amine based chemi-sorption. Carbonyl sulfide (COS) can be removed using an aqueous treatment system. In some embodiments, the products can be separated using a membrane system or a cryogenic distillation system. FIGS. 6-8 are schematics of non-limiting examples of recovery or separation systems. FIG. 6 is a schematic of a membrane separation system. FIG. 7 is a schematic of a cryogenic distillation system. FIG. 8 is a schematic of a cryogenic distillation system to separation carbon dioxide from sulfur dioxide.

4. Membrane Separation System for Second Product Stream

Referring to FIG. 6, membrane separation system 600 is in fluid communication with the second product stream from the systems described in FIGS. 2-5. The second product stream 230 can include gaseous carbon monoxide, gaseous carbonyl sulfide, and gaseous sulfur dioxide. In some embodiments, the gaseous product stream includes gaseous carbon disulfide and gaseous sulfur. The gaseous product stream 230 can pass through heat exchangers 602 and 604 in a sequential manner and undergo multiple heat exchanges to reduce the temperature of product stream 230. Cooled gaseous product stream 230 can enter condenser 606, which is at a temperature sufficient to separate liquid SO₂ from gaseous product stream 230 and form liquid sulfur dioxide stream 608 and gaseous product stream 610. In some embodiments, the temperature of the condenser ranges from −150 to −55° C. Liquid sulfur dioxide stream 608 exits condenser 606 and passes through heat exchanger 604 to produce gaseous sulfur dioxide stream 612. In heat exchanger 604, heat transfer between hot gaseous product stream 230 and liquid sulfur dioxide stream 608 can be sufficient to gasify all, or substantially all, of the sulfur dioxide in sulfur dioxide stream 612. Gaseous sulfur dioxide stream 612 can be transported to storage units, transported to other processing units to be converted into other commercial products, and/or sold.

Gaseous product stream 610 can exit condenser 606, pass through heat exchanger 602, compressor 612, and then enter membrane unit 614. As the gaseous product stream 610 passes through heat exchanger 602, gaseous product stream 610 is heated by exchange of heat with the hot gaseous second product stream 230. Compression of heated gas product stream 610 can further heat the gaseous product stream to a desired temperature for separation in membrane separation unit 614. In some embodiments, compressor 612 is not necessary. Heated gaseous product stream 610 enters membrane separation unit 614 through feed inlet 616. In the membrane separation unit 614, carbonyl sulfide can be separated from gaseous product stream 610 to form carbonyl sulfide stream 618 and gaseous carbon monoxide stream 620. A portion of gaseous carbonyl sulfide stream 332 can be transported to other units or to storage units, or sold through conduit 336. A portion of gaseous carbonyl stream 332 can be provided to first reaction zone 204 and/or first reactor 502. In some embodiments, a gaseous sulfur stream, a gaseous carbon dioxide stream and a gaseous carbonyl sulfide stream, or combinations thereof are provided directly as single streams or mixtures of streams to second reaction zone 206 and/or second reactor 504. Gaseous carbon monoxide stream 618 can enter scrubber 622. In scrubber 622, residual amounts of carbonyl sulfide and/or sulfur dioxide can be removed from gaseous carbon monoxide stream 618 to produce purified carbon monoxide stream 624. Scrubber 622 can be any known scrubber system capable of separating COS and SO₂ from CO. For example, scrubber 622 may be an aqueous treatment system. Waste product stream 626 containing carbonyl sulfide, sulfur dioxide, and water can exit scrubber system 622 and be disposed of using known disposal methods. Purified carbon monoxide stream 624 can exit scrubber 622 and be transported to other units for further processing into commercial products, stored, or sold.

5. Cryogenic Separation System for Second Product Stream

Referring to FIG. 7, cryogenic separation system 700 is in fluid communication with the second product stream from the systems described in FIGS. 2-5. System 700 includes heat exchangers 602, 604, and 702, condenser 606, and cryogenic separation unit 704. Gaseous product stream 230 enters condenser 606, which is at a temperature sufficient to separate liquid SO₂ from the gaseous product stream and form liquid sulfur dioxide stream 608 and gaseous product stream 610. In some embodiments, the temperature of condenser 606 ranges from −150 to −55° C. Liquid sulfur dioxide stream 608 exits condenser 606 and can undergo heat exchange in heat exchanger 604 to produce gaseous sulfur dioxide stream 612. In heat exchanger 604, hot gaseous product stream 230 can be used as the working fluid to provide heat to liquid sulfur dioxide stream 608 to sufficiently to gasify all, or substantially gasify all, of the liquid sulfur dioxide in sulfur dioxide stream 612 to gaseous sulfur dioxide. Gaseous sulfur dioxide stream 612 can be transported to storage units, transported to other processing units to be converted into other commercial products, and/or sold.

Gaseous product stream 610 can exit condenser 606 and pass through heat exchanger 702. Heat exchange in heat exchanger 702 can cool gaseous product stream 610. For example, the temperature of the working fluid in heat exchanger 702 can be about −50° C. Gaseous product stream 610 can enter cryogenic separation unit 704. In some embodiments, heat exchanger 702 is not used, and gaseous product stream 610 enters cryogenic separation unit 704. In cryogenic separation unit 704, carbon monoxide is separated from gaseous product stream 610 to form carbon monoxide stream 706. Cryogenic separation unit 704 may have 2 to 100, 20 to 50, or 30 to 40 distillation plates and be operated at temperatures and pressures sufficient to separate carbon monoxide from gaseous product stream 610. For example, cryogenic distillation can be operated at a temperature of −140 to −55° C. Purified carbon monoxide stream 706 can exit cryogenic separation unit 704 pass through heat exchanger 602 and be transported to storage units, other process facilities or sold as a commercial product. Carbon monoxide stream 706 can have 90 to 100%, or preferably 100% by volume carbon monoxide. While passing through heat exchanger 602, cold carbon monoxide stream 706 may cool hot gaseous second product stream 230 exiting second reactor 506 and/or second reaction zone 206 as described in FIGS. 2-5, and thus, improve the heat efficiency of the system. In some embodiments, carbon monoxide stream 706 does not pass through heat exchanger 602. In cryogenic separation unit 704, conditions are sufficient to liquefy or partially liquefy carbonyl sulfide (i.e., at temperatures below the boiling point of carbonyl sulfide (about −50° C.) and form liquid carbonyl sulfide stream 708. Liquid carbonyl sulfide stream 708 can exit cryogenic separation unit 704 and pass through heat exchanger 702. In heat exchanger 702, liquid carbonyl sulfide stream 708 is gasified to form gaseous carbonyl sulfide stream 708. Heat in heat exchanger 702 can be provided from gaseous product stream 610, thus maximizing the heat efficiency of cryogenic distillation system 700. Gaseous carbonyl sulfide stream 708 can enter first reaction zone 204 and/or 502 or be mixed with streams entering the first reaction zone.

6. Separation System for First Product Stream

The first product stream can undergo a similar cryogenic distillation as described for FIG. 7. FIG. 8 depicts a schematic for separating carbon monoxide from sulfur dioxide from the first product stream. Referring to FIG. 8, cryogenic separation system 800 is in fluid communication with the first product stream from the systems described in FIGS. 2-5. System 800 includes heat exchangers 802, 804, and condenser 806. Gaseous first product stream 216 enters condenser 806, which is at a temperature sufficient to separate liquid SO₂ from the gaseous product stream and form liquid sulfur dioxide stream 808 and gaseous product stream 810. In some embodiments, the temperature of condenser 806 ranges from −150 to −55° C. Liquid sulfur dioxide stream 808 exits condenser 806 and can undergo heat exchange in heat exchanger 804 to produce gaseous sulfur dioxide stream 812. In heat exchanger 804, hot gaseous product stream 216 can be used as the working fluid to provide heat to liquid sulfur dioxide stream 808 to sufficiently to gasify all, or substantially gasify all, of the liquid sulfur dioxide in sulfur dioxide stream 808 to gaseous sulfur dioxide. Gaseous sulfur dioxide stream 812 can be transported to storage units, transported to other processing units to be converted into other commercial products, and/or sold.

Gaseous product stream 810 can exit condenser 806 and pass through heat exchanger 802, and be transported to storage units, other process facilities or sold as a commercial product, or recycled to second reaction zone 206 and/or 506. Carbon dioxide stream 810 can have 90 to 100%, or preferably 100% by volume carbon dioxide. While passing through heat exchanger 802, cold carbon dioxide stream 810 may cool hot gaseous first product stream 216 exiting second reactor 506 and/or second reaction zone 206 described in FIGS. 2-5, and thus, improves the heat efficiency of the system. In some embodiments, carbon dioxide stream 810 does not pass through heat exchanger 802.

With respect FIGS. 2-8, not all conduits and vessel inlets and outlets are described as it should be understood that the units described in the figures have inlets, outlets and conduits that in fluid communication. It should also be understood that the arrangement of the components in the systems can be combined and/or used in a different order.

### B. First and Second Reaction Mixtures

The first reaction mixture can include any mixture that produces heat upon reacting. In one embodiment, the first reaction mixture can include carbonyl sulfide (COS) and an oxidant source. The COS can be obtained from the reaction of carbon dioxide and sulfur as described below. COS can be obtained from various commercial vendors. A non-limiting example of a commercial vendor is Praxair, Inc. (USA). The oxidant source can be oxygen (O₂) gas, air, or oxygen enriched air. The oxidant is available from various commercial vendors. A non-limiting example of a commercial vendors for COS and oxidants is Praxair, Inc. (USA). In the first reaction mixture, a molar ratio of O₂(g) to COS(g) can range from 0.1 to 2 or 1.5 and any range therein. Ratios lower than 0.1:1 and higher than 2:1 are also contemplated in the context of the present invention. Ultimately, the ratio can be varied to produce a desired reaction product profile.

The second reaction mixture or gaseous reaction mixture in the context of the present invention can include a gaseous mixture that includes, but is not limited to, sulfur gas (S(g)), and carbon dioxide gas (CO₂(g)). Alternatively, the S(g) and CO₂(g) feeds can be introduced separately and mixed in a reactor. Sulfur gas (S(g)) in the context of the present invention can be referred to as elemental sulfur and can include all allotropes of sulfur (i.e., Sₙ where n=1 to infinity). Non-limiting examples of sulfur allotropes include S, S₂, and S₃. Sulfur gas (S₁₋₃) can be obtained by heating solid or liquid sulfur to its boiling point of about 115° C. Solid sulfur can contain either (a) sulfur rings, which may have 6, 8, 10 or 12 sulfur atoms, with the most common form being S₈, or (b) chains of sulfur atoms, referred to as catenasulfur having the formula S_{∞}. Liquid sulfur is typically made up of Ss molecules and other cyclic molecules containing a range of six to twenty atoms. Solid sulfur is generally produced by extraction from the earth using the Frasch process, or the Claus process. The Frasch process extracts sulfur from underground deposits. The Claus process produces sulfur through the oxidation of hydrogen sulfide (H₂S). Hydrogen sulfide can be obtained from waste or recycle stream (for example, from a plant on the same site, or as a product from hydrodesulfurization of petroleum products) or recovery the hydrogen sulfide from a gas stream (for example, separation for a gas stream produced during production of petroleum oil, natural gas, or both). A benefit of using sulfur as a starting material is that it is abundant and relatively inexpensive to obtain as compared to hydrogen gas. Carbon dioxide used in the present invention can be obtained from various sources. In one non-limiting instance, the carbon dioxide can be obtained from a waste or recycle gas stream (e.g., from a plant on the same site, like for example from ammonia synthesis) or after recovering the carbon dioxide from a gas stream. A benefit of recycling such carbon dioxide as a starting material in the process of the invention is that it can reduce the amount of carbon dioxide emitted to the atmosphere (e.g., from a chemical production site). In the second reaction mixture, a molar ratio of CO₂(g) to S(g) can range from 1:1 to 6:1 and any range therein. Ratios lower than 1:1 and higher than 6:1 are also contemplated in the context of the present invention. Ultimately, the ratio can be varied to produce a desired reaction product profile.

The first and second reaction mixtures can further contain other gases, provided that these do not negatively affect the reaction. Examples of such other gases include nitrogen or argon. In some aspects of the invention, the reactant gas stream is substantially devoid of other reactant gas such as hydrocarbon gases, oxygen gas, hydrogen gas, water or any combination thereof. Hydrocarbon gases include, but are not limited to, C₁ to C₅ hydrocarbon gases, such as methane, ethylene, ethane, propane, propylene, butane, butylene, isobutene, pentane and pentene. In a particular aspect of the invention the gaseous feed contains 0.1 wt. % or less, or 0.0001 wt. % to 0.1 wt. % of combined other reactant gas.

### C. Reaction Products

The products made from the reduction of carbon dioxide with elemental sulfur in the gas phase can be varied by adjusting the molar ratio of CO₂(g) to S(g), the reaction conditions, or both. The major products produced from the reaction of carbon dioxide and sulfur is carbon monoxide and sulfur dioxide as shown in reaction equations (6) and (9). Table 1 lists the enthalpy, entropy and Gibbs free energy for reactions (6) through (10). The other products that can be produced by the reaction include CS₂ and COS as shown in equation (11), with 10% or less of the reaction product being CS₂ at any ratio of CO₂ to S. In some aspects of the invention, the distribution of products in the product stream (for example, COS(g), SO₂, CS₂, CO₂, CO and SO₂) can be controlled by adjusting the ratio of carbon dioxide to sulfur from 1:1 to 2:1 and up to 6:1 and the temperature of the reaction.

CO₂(g)+S(g)→COS(g)+SO₂(g)+CS₂(g)+CO(g) (11)

TABLE 1

| | ΔH, | ΔS, | | ΔH, | | | ΔH, | | |
|---|---|---|---|---|---|---|---|---|---|
| | 100° C., | 100° C., | ΔG, | 500° C., | ΔS, 500° C., | ΔG, 500° C., | 1100° C., | ΔS, 1100° C., | ΔG, 1100° C., |
| Reaction | kcal | kcal | 100° C. | kcal | cal/K | kcal | kcal | cal/K | kcal |
| COS + 1.5O₂ = | −131.2 | −18.9 | −124.1 | −131.4 | −19.5 | −116.4 | −131.3 | −19.4 | −104.7 |
| CO₂ + SO₂ | | | | | | | | | |
| 2CO₂ + S = | −2.34 | 11.4 | −6.6 | −2.8 | 10.6 | −11.0 | −4.1 | 9.4 | −17.0 |
| CO + SO₂ | | | | | | | | | |
| 4CO₂ + S₂ = | 98.1 | 49.3 | 79.7 | 98.0 | 49.4 | 59.8 | 96.2 | 47.7 | 30.7 |
| 4CO + SO₂ | | | | | | | | | |
| CO + S = COS | −74.3 | −32.5 | −62.2 | −74.6 | −33.1 | −49.0 | −74.2 | −32.8 | −29.2 |
| 2CO + S₂ = | −45.9 | −38.6 | −31.5 | −45.5 | −38.1 | −16.1 | −44.0 | −36.6 | 6.32 |
| 2COS | | | | | | | | | |

1. COS Formation

Without wishing to be bound by theory, it is believed that, as shown in equation (12), carbon dioxide initially reacts with sulfur to form carbonyl sulfide and oxygen. In some aspect of the invention, the amount of COS(g) produced can be adjusted by varying the temperature of the reaction. At a temperature 400° C. and 700° C., the product stream contains COS and SO₂ with a minimal amount of CO. At these temperatures, the ratio of COS:SO₂ can be 2:1 or 1:1. In some aspects of the invention, the COS can be separated from the SO₂ and CO₂ as described throughout this Specification and sold or further processed into other chemical products or recycled back to the first reaction zone to be used as fuel for heat.

2CO₂(g)+2S(g)→2 COS(g)+O₂(g) (12)

2. CO and SO₂ Formation

Without wishing to be bound by theory, it is believed that the carbonyl sulfide and oxygen in equation (12) react with carbon dioxide and sulfur to form SO₂ and CO as shown in equations (13) and (14). In some aspects of the invention, CO and SO₂ are produced at temperatures between 700 and 3000° C., 900 to 2000° C., or 1500 to 1700° C., with a preferred temperature of between 1000 and 1600° C. and CO₂ to S ratios of 1:1 to 2:1, and up to 6:1. In other instances, however, lower temperatures are also contemplated (e.g., 250° C. or more or certain temperature and pressure conditions can be used to ensure sulfur is in the gaseous phase—e.g., conditions at which substantial vapor pressure of S exists, e.g., vapor pressure of S is 5×10⁴ atm at 119° C. and 1 atm at 444.6° C.). The ratio of CO(g) to SO₂(g) in the product mixture can range from 0.1:1, 1:2, 1:1, 2:1. The temperature of the reaction and/or CO₂/S ratio can be adjusted to produce a desired CO/SO₂ ratio. For example, if a high CO/SO₂ is desired, a temperature of 1200° C. can be used instead of 1500° C. On the other hand, if a high CO/COS ratio is desired, a CO₂/S ratio of 6:1 and temperature of 1500° C. or 1200° C. can be used. The of equilibrium ratios of CO(g) to SO₂(g) at 918° C., 1120° C. and 1500° C. and different temperatures are summarized in Table 2.

S(g)+O₂(g)→SO₂(g) (13)

COS(g)+2CO₂(g)→SO₂(g)+3CO(g) (14)

TABLE 2

| CO₂:S | CO:SO₂ ratio | CO:SO₂ ratio | CO:SO₂ ratio |
|---|---|---|---|
| ratio | at 918° C. | at 1120° C. | at 1500° C. |
| 6:1 | 0.8:1 | 1.78:1 | 2:1 |
| 4:1 | 0.55:1 | 1.55:1 | 1.9:1 |
| 2:1 | 0.3:1 | 1.1:1 | 1.6:1 |
| 1:1 | 0.1:1 | 0.9:1 | 0.5:1 |

A ratio of CO/COS at about 900° C. is about 120:1 with a starting CO₂ to S ratio of 6:1. Equilibrium ratio of CO₂ to the combined CO and SO₂ is summarized in Table 3.

TABLE 3

| CO₂:S | CO₂/(CO + SO₂) | CO₂/(CO + SO₂) | CO₂/(CO + SO₂) |
|---|---|---|---|
| ratio | ratio at 918° C. | ratio at 1120° C. | ratio at 1500° C. |
| 6:1 | 6.2:1 | 2:1 | 1.2:1 |
| 4:1 | 4.9:1 | 1.5:1 | 0.8:1 |
| 2:1 | 2.8:1 | 0.8:1 | 0.3:1 |
| 1:1 | 1:1 | 0.1:1 | 0.5:1 |

Without wishing to be bound by theory, it is believed that at temperatures above 1500° C., additional CO(g) is formed through the decomposition of any remaining COS to CO(g) and S(g) as shown in equation (15). In embodiments when the CO₂ to S ratio is greater than 2:1, the COS(g) decomposition can be suppressed.

COS(g)→CO(g)+S(g) (15)

3. CS₂ Formation

In certain aspects of the invention when the ratio of CO₂ to S is 1:1 or 2:1, and the temperature of the reaction is from about 445 to about 700° C., the amount of CS₂ formed as shown in equation (16). The amount of carbon disulfide produced can be about 10% or less on a molar basis. The oxygen produced can react with sulfur to form sulfur dioxide.

CO₂(g)+2S(g)→CS₂(g)+O₂(g) (16)

In some aspects of the invention, to inhibit or reduce the amount of carbon disulfide formation, the amount of CO₂ can be increased in the reaction mixture. Without wishing to be bound by theory, it is believed that the increased CO₂ reacts with the CS₂ to give CO and SO₂ at higher concentrations of CO₂. In some aspects of the invention, at a CO₂:S ratio of 4:1, no, or undetectable amounts of, CS₂ is formed at temperatures between 400 to 3000° C. It is believed that at temperatures greater than 1000° C., any carbon disulfide that is generated decomposes to carbon monosulfide CS(g) and S(g). The generated sulfur can react with excess carbon dioxide to continue production of COS, CO and SO₂. Without wishing to be bound by theory, it is believed that the carbon monosulfide can polymerize at reaction temperatures above 1000° C.

### D. Catalysts and Reaction Conditions

Catalytic material used in the context of this invention may be the same catalysts, different catalysts, or a mixture of catalysts. The catalysts may be supported or unsupported catalysts. The support may be active or inactive. The catalyst support can include refractory oxides, alumina oxides, aluminosilicates, silicon dioxide, metal carbides, metal nitrides, sulfides, or any combination thereof. Non-limiting examples of such compounds includes MgO, Al₂O₃, SiO₂, Mo₂C, TiC, CrC, WC, OsC VC, Mo₂N, TiN, VN, WN, CrN, Mo₂S, ZnS, and any combination thereof. All of the support materials can be purchased or be made by processes known to those of ordinary skill in the art (e.g., precipitation/co-precipitation, sol-gel, templates/surface derivatized metal oxides synthesis, solid-state synthesis, of mixed metal oxides, microemulsion technique, solvothermal, sonochemical, combustion synthesis, etc.). One or more of the catalysts can include one or more metals or metal compounds thereof. The metals that can be used in the context of the present invention to create bulk metal oxides, bulk metal sulfides, or supported catalysts include a metal from Group IIA or compound thereof, a metal from Group IB or compound thereof, a metal from Group IIIB or compound thereof, a metal from Group IVB or compound thereof, a metal from Group VIB or compound thereof, a metal from Group VIII or compound thereof, at least one lanthanide or compound thereof, or any combination thereof. The metals or metal compounds can be purchased from any chemical supplier such as Sigma-Aldrich® (USA), Alfa-Aeaser (USA), Strem Chemicals (USA), etc. Group IIA metals (alkaline-earth metals) and Group IIA metal compounds include, but are not limited to, Mg, MgO, Ca, CaO, Ba, BaO, or any combinations thereof. Group IB metals and Group IB metal compounds include, but are not limited to, Cu and CuO. Group IIB metals include zinc or zinc sulfide. Group IIIB metals and Group IIIB metal compounds include, but are not limited to, Sc, Sc₂O₃, the lanthanides or lanthanide compounds, or any combination thereof. Lanthanides that can be used in the context of the present invention to create lanthanide oxides include La, Ce, Dy, Tm, Yb, Lu, or combinations of such lanthanides. Non-limiting examples of lanthanide oxides include CeO₂, Dy₂O₃, Tm₂O₃, Yb₂O₃, Lu₂O₃, or La₂O₃, or any combination thereof. Lanthanide oxides can be produced by methods known in the art such as by high temperature (e.g., >500° C.) decomposition of lanthanide salts or by precipitation of salts into respective hydroxides followed by calcination to the oxide form. Group IVB metals and Group IV metal compounds include, but are not limited to, Zr and ZrO₂. Group VIB metals and Group VI metal compounds include, but are not limited to, Cr, Cr₂O₃, Mo, MoO, Mo₂O₃, or any combination thereof. Group VIII metals and metal compounds include, but are not limited to, Ru, RuO₂, Os, OsO₂, Co, Co₂O₃, Rh, Rh₂O₃, Ir, Ir₂O₃, Ni, Ni₂O₃, Pd, Pd₂O₃, Pt, Pt₂O₃, or combinations thereof. The catalytic material can be subjected to conditions that results in sulfurization of the metal in the catalytic material. Non-limiting examples of metal that can be sulfided prior to use are Co, Mo, Ni and W. The catalyst material can, in some instances include a promoter compound. A non-limiting example of promoter compound is phosphorus. A non-limiting example of a catalyst that includes a promoter compound is catalyst material that includes Mo—Ni—P. In some instances, the metal oxides described herein can be of spinel (general formula: M₃O₄), olivine (general formula: M₂SiO₄) or perovskite (general formula: M¹M²O₃) classification.

The catalyst used in the present invention is sinter and coke resistant at elevated temperatures, (e.g., 445° C. to 3000° C., 900 to 2000° C., or 1000 to 1600° C.). Further, the produced catalysts can be used effectively in reaction of sulfur with carbon dioxide at a pressure of 1 to 25 bar, and/or at a gas hourly space velocity (GHSV) range from 1000 to 100,000 h⁻¹.

### E. Further Processing of Products

1. CO Processing

The carbon monoxide produced using the method of the invention can be partially converted into H₂ through water gas shift reaction for the production of syngas of desired H₂/CO ratio as shown in equation (17). The produced CO₂ can be used in the current process to produce more carbon monoxide. This provides an efficient, economic, and novel method to convert a greenhouse gas (CO₂) into value added and useful products.

CO+H₂O→H₂+CO₂ (17)

2. SO₂ Processing

The sulfur dioxide produced using the method of the invention can be converted to SO₃, which can be further processed into sulfuric acid and ammonium sulfate as shown in the equations (18) through (21).

SO₂+½O₂→SO₃ (18)

SO₃+H₂SO₄″H₂S₂O₇ (19)

H₂S₂O₇+H₂O→2H₂SO₄ (20)

2NH₃+H₂SO₄→(NH₄)₂SO₄ (21)

3. COS Processing

The carbonyl sulfide produced using the method of the invention can be used in the production of thiocarbamates. Thiocarbamates can be used in commercial herbicide formulations. The method of the invention provides an advantage over commercially prepared COS, which is synthesized by treatment of potassium thiocyanate and sulfuric acid as shown in equation (22).

KSCN+2H₂SO₄+H₂O→KHSO₄+NH₄HSO₄+COS (22)

The conventional treatment produces potassium bisulfate and ammonium bisulfate which needs to be separated, which is a difficult and time consuming process. The method of the invention provides an efficient and economic method solution to the production of COS.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Exothermic Calculations

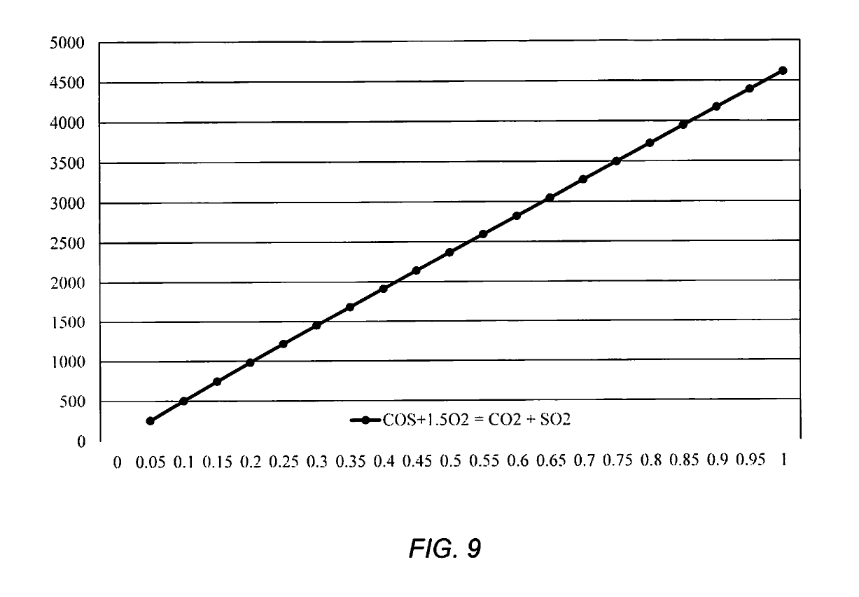

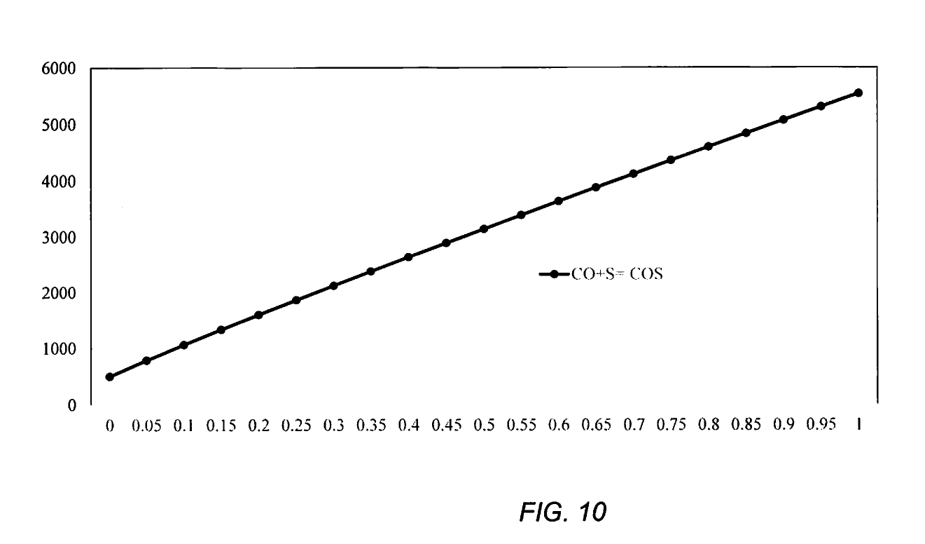

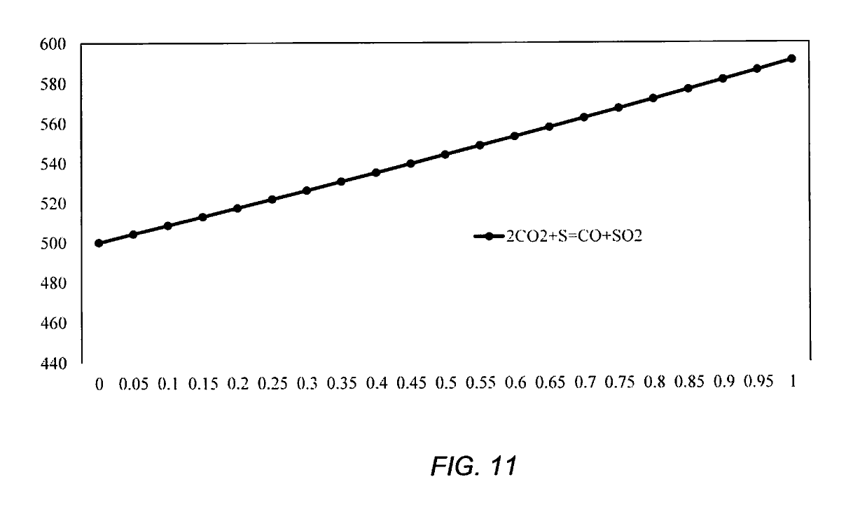

Exothermic calculations were done by using aspenONE Version 8.6 software provided by Aspentech. FIGS. 9-11 are graphs of the calculated exotherms for conversion of COS with oxygen (FIG. 9), CO with sulfur (FIG. 10) and CO₂ with elemental sulfur (FIG. 11) versus heat trace across the bed. Table 4 lists the conversions and corresponding delta % raise for the three different reactions.

TABLE 4

| COS = 1.5O₂ = CO₂ + SO₂ | | | 2CO₂ + S = CO + SO₂ | | | CO + S = COS | | |
|---|---|---|---|---|---|---|---|---|
| | Absolute | ΔT, ° C. | | Absolute | ΔT, ° C. | | Absolute | ΔT, ° C. |
| Conversion | T, ° C. | raise | Conversion | T, ° C. | raise | Conversion | T, ° C. | raise |
| 0 | 500 | | 0 | 500 | | 0 | 500 | |
| 0.05 | 756 | 256 | 0.05 | 504 | 4.3 | 0.05 | 784 | 284.7 |
| 0.1 | 1003 | 503 | 0.1 | 508 | 8.63 | 0.1 | 1062 | 562.3 |
| 0.15 | 1244 | 744 | 0.15 | 512 | 13 | 0.15 | 1333 | 833.8 |
| 0.2 | 1481 | 981 | 0.2 | 517 | 17.4 | 0.2 | 1600 | 1100.6 |
| 0.25 | 1716 | 1216 | 0.25 | 521 | 21.8 | 0.25 | 1863 | 1363.5 |
| 0.3 | 1949 | 1449 | 0.3 | 526 | 26.2 | 0.3 | 2123 | 1623.4 |
| 0.35 | 2180 | 1680 | 0.35 | 530 | 30.6 | 0.35 | 2380 | 1880.5 |
| 0.4 | 2410 | 1910 | 0.4 | 535 | 35.1 | 0.4 | 2635 | 2187.4 |
| 0.45 | 2639 | 2139 | 0.45 | 539 | 40 | 0.45 | 2887 | 2387.8 |
| 0.5 | 2867 | 2367 | 0.5 | 544 | 44.2 | 0.5 | 3137 | 2637.6 |
| 0.55 | 3094 | 2594 | 0.55 | 548 | 48.7 | 0.55 | 3385 | 2885.8 |
| 0.6 | 3321 | 2821 | 0.6 | 553 | 53.3 | 0.6 | 3631 | 3132 |
| 0.65 | 3447 | 3047 | 0.65 | 557 | 58 | 0.65 | 3876 | 3376.3 |
| 0.7 | 3772 | 3272 | 0.7 | 562 | 62.6 | 0.7 | 4118 | 3618.7 |
| 0.75 | 3997 | 3497 | 0.75 | 567 | 67.3 | 0.75 | 4359 | 3859.3 |
| 0.8 | 4221 | 3721 | 0.8 | 571 | 71.7 | 0.8 | 4598 | 4098.2 |
| 0.85 | 4445 | 3945 | 0.85 | 576 | 76.7 | 0.85 | 4835 | 4335.3 |
| 0.9 | 4669 | 4169 | 0.9 | 581 | 81.5 | 0.9 | 5070 | 4570.7 |
| 0.95 | 4892 | 4392 | 0.95 | 586 | 86.2 | 0.95 | 5304 | 4804.3 |
| 1 | 5115 | 4615 | 1 | 591 | 91 | 1 | 5536 | 5036.3 |

1. A system for producing carbon monoxide (CO) and sulfur dioxide (SO₂), the system comprising:
(a) a first reaction zone configured to produce heat from an exothermic reaction of a first reaction mixture and a first product stream;
(b) a second reaction zone comprising a gaseous reaction mixture of carbon dioxide (CO₂(g)) and elemental sulfur and configured to receive the produced heat from the first reaction zone in an amount sufficient to heat the gaseous reaction mixture and produce a second product stream comprising CO and SO₂;
(c) a first outlet in fluid communication with the first reaction zone and configured to remove the first product stream from the first reaction zone; and
(d) a second outlet in fluid communication with the second reaction zone and configured to remove the second product stream comprising CO and SO₂ from the second reaction zone.

2. The system of claim 1, wherein exothermic first reaction mixture comprises carbonyl sulfide (COS) and oxygen source oxygen (O₂) and the first product stream comprises CO₂ and SO₂.

3. The system of claim 1, wherein the second reaction zone encompasses the first reaction zone.

4. The system of claim 3, wherein the first reaction zone and the second reaction zone form a concentric reactor, and wherein the first reaction zone is the annulus of the concentric reactor.

5. The system of claim 1, wherein the first product stream absorbs heat from the exothermic reaction, and the system further comprises a heat exchanging unit in fluid communication with the first outlet and the second reaction zone and configured to exchange heat between the heated first product stream and the second reaction mixture and providing the heated second reaction mixture to the second reaction zone.

6. The system of claim 5, wherein second gaseous reaction mixture further comprises CO₂ and elemental sulfur.

7. The system of claim 1, wherein the produced heat from the first reaction zone is sufficient to drive the CO₂ with the elemental sulfur reaction, a CO and elemental sulfur reaction, or both in the second reaction zone.

8. The system of claim 1, wherein the temperature of the produced heat is at least 250° C.

9. The system of claim 8, wherein the temperature of the produced heat is 250° C. to 2500° C., preferably 900° C. to 2300° C., most preferably 1000° C. to 2200° C.

10. The system of claim 1, wherein the system is thermoneutral.

11. The system of claim 1, wherein the first reaction outlet is configured to provide the produced heat to another system, preferably a power generating system.

12. The system of claim 1, wherein the second reaction zone comprises a catalyst capable of catalyzing the reaction of CO₂ and elemental sulfur to produce the second product stream comprising COS, CO and SO₂.

13. The system of claim 1, wherein the second product stream comprises COS.

14. A method of producing carbon monoxide (CO) and sulfur dioxide (SO₂), the method comprising:
(a) providing a first reaction mixture capable of undergoing an exothermic reaction to a first reaction zone;
(b) subjecting the first reaction mixture to conditions sufficient to produce a first product stream and heat;
(c) providing a second reaction mixture comprising carbon dioxide (CO2) and elemental sulfur gas to a second reaction zone;
(d) transferring the produced heat to the second reaction zone; and
(e) producing a second product stream comprising CO and SO2 from the second reaction mixture.

15. The method of claim 14, wherein the first reaction mixture comprises carbonyl sulfide (COS) and oxygen gas (O₂) and the first product stream comprises CO₂ and SO₂.

16. The method of claim 14, wherein transferring the heat comprises allowing the heat to transfer from the first reaction zone to the second reaction zone and/or transferring the produced heat from the first product stream to the second product stream.

17. The method of claim 14, wherein the temperature of the second reaction mixture is 250° C. to 3000° C., preferably 900° C. to 2000° C., most preferably 1000° C. to 1600° C., the reaction pressure in the second reaction zone is 1 to 25 bar, or both.

18. The method of claim 14, wherein the transferred heat provides sufficient heat to drive the carbon dioxide (CO₂) and elemental sulfur gas reaction or a carbon monoxide and elemental sulfur reaction, or both in the second reaction zone.

19. The method of claim 14, wherein the temperature in the first reaction zone is at least 1000° C., the reaction temperature in step (b) is 700° C. to 2500° C., preferably 900° C. to 2300° C., most preferably 1000° C. to 2500° C., reaction pressure in the first reaction zone is 0.1 to 50 bar, or combination thereof.

20. The method of claim 14, wherein the second reaction zone comprises a catalyst capable of catalyzing the reaction of CO₂ and elemental sulfur to produce the second product stream comprising COS, CO and SO₂.
